(19) United States
(12) Patent Application Publication
(10) Pub. No.: US 2008/0031604 A1
(43) Pub. Date: Feb. 7, 2008

(54) Heating Device

(75) Inventor: Margarete Kerschbaum, Wien (AT)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(73) Assignee: KERSCHBAUM, WOLFGANG, WIEN (AT)

(21) Appl. No.: 11/576,781

(22) PCT Filed: Oct. 4, 2005
(86) PCT No.: PCT/EP05/10649

§ 371 Date: Apr. 5, 2007

(30) Foreign Application Priority Data
Oct. 5, 2004 (AT) A 1651/2004

(51) Int. Cl. H05B 3/26; H05B 3/74

(52) U.S. Cl. 392/435

(57) ABSTRACT

The invention relates to a heating device 1 comprising a base plate 2 and a heating element 3. It is defined by the base plate 2 consisting of an insulating material and the heating element being embedded in it and mounted in a groove 8 in the base plate 2, the heating element 3 being designed as a flexible, wire-shaped electrical heat conductor made of non-metallic material, the base plate 2 being made of sintered expanded glass granulate, and the heating element 3 advantageously being made of a carbon wire.

This application is based on PCT/EP2005/010649 claiming priority of Austrian patent application A 1651/2004 having a filing date of 05 Oct. 2004, the entire content of which is herewith incorporated by reference.

### BACKGROUND OF THE INVENTION

The invention relates to a heating device consisting of a base plate and a heating element.

Heating devices of this type are known in many embodiments. For example, DE 203 14 061 U1 shows a heating panel for heating rooms electrically and which comprises a base plate of mineral material and inner pores, as well as a heating mat mounted on a flat face. In order to create the desired pores here, a complex process is required. In addition, the heating mat, which is often difficult to access, must adhere well to the base plate. A heating device of different design is described in DE 100 19 315 A1. This element is used for heating with hot water and has embedded heating and cooling tubes. The heating device described in AT 006 132 U1 consists of two laminated plastic panels with a carbon fleece embedded between the two. All of these heating devices are very complex to manufacture and also have an inexact heating capacity.

Further, DE 44 47 408 A describes a heating element made up of several layers, which is intended as an underfloor heating element and thus, must withstand the corresponding loads. In particular, a top wearing layer made of plastic is mounted here on a layer of PVC. Underneath there is a planiform fibre web, for example a carbon fibre fleece. The whole unit is designed in strips. EP 0 719 074 A2 describes a heating element of similar design. DD 115 413 describes the use of cellular glass as heat-insulating material for a radiant panel heater, among other things.

### SUMMARY OF THE INVENTION

The present invention should now avoid these disadvantages, the intention being to make use of the advantages of heating by heat rays.

It is thus defined by the base plate consisting of an insulating material and the heating element is embedded in it, and the heating element is designed as a flexible, wire-shaped electrical heat conductor made of non-metallic material. The flexibility of the heating conductor permits low-cost manufacture, with the non-metallic material displaying good heat radiation properties.

An advantageous development of the invention is defined by the base plate being made of sintered expanded glass granulate. With this design, good insulation is guaranteed with simple manufacturing. The base plate can also comprise a honeycomb of aramid paper coated with phenolic resin (Nomex honeycomb) or an aluminium honeycomb. These also have good insulating effect due to the air cavities.

A favourable embodiment of the invention is defined by the heating element being made of a carbon wire. A precise heating capacity can be achieved with the carbon wire due to its pre-determined length.

An advantageous development is defined by the heating element being provided within a groove in the base plate. By being mounted in a groove, the heating element can be secured well and also mounted with great precision. As a result, even heat emission is guaranteed and lower energy consumption achieved at the same temperature.

A favourable development of the invention is defined by a cover plate with irradiating properties being mounted on a flat face of the base plate, wherein this cover plate can be made of glass-lined steel or coated aluminium sheet. Due to this arrangement, heat emission, for example into a room, becomes more even.

It has proven to be particularly favourable to have the heating element in direct contact with the cover plate. Since the heat is conducted evenly, heat emission also becomes more even.

An advantageous embodiment of the invention is defined by a heat-reflecting cover plate being provided on one flat face of the base plate, particularly the lower one, where the heat-reflecting plate can be of sheet steel, aluminium sheet, or zinc sheet. The heat emission is reflected by this plate in such a way that it only radiates from one side of the plate, while the other side remains relatively cool. In this way, it is possible to manufacture plates that can be mounted on the walls of living or working areas, for example. In principle, these plates could also be used in floors as underfloor heating.

### BRIEF DESCRIPTION OF THE DRAWINGS

The invention will now be described in examples using the following drawings, where

FIG. 1 shows a view of the base plate of a heating device according to the invention, and

FIG. 2 provides a sectional view through a heating device along the line marked II-II in FIG. 1.

### DETAILED DESCRIPTION OF THE DRAWINGS

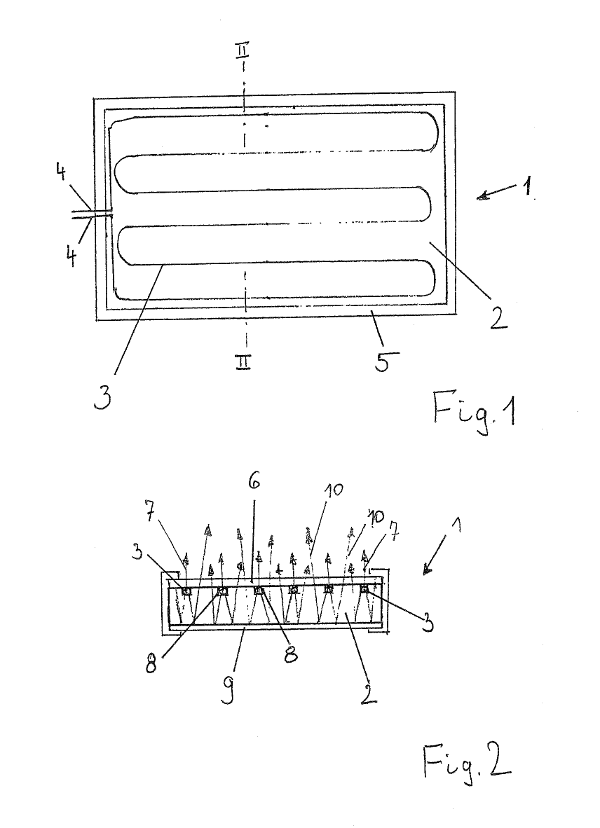

FIG. 1 shows the main element of the heating device 1, which consists of a base element 2 into which the heating element 3 is embedded. The base element 2 consists of an insulating material, where expanded glass granulate has proved particularly favourable. For particularly light heating devices, it would also be possible to use a so-called Nomex honeycomb or an aluminium honeycomb. The Nomex honeycomb is made of aramid paper coated with phenolic resin and combines high strength properties with very low weight, while also being resistant to impact and fatigue. Due to the honeycomb shape, air is stored in the cavities and acts as an insulating medium. The aluminium honeycomb also has very good stability. These advantages compensate for the higher material costs in special cases. If this material is chosen, all possible shapes of base element 2 can also be used quite easily, from a circle to an oval, a square or a rectangle. The base element 2 can be made of expanded glass granulate that is either sintered or hot-pressed, after which the grooves for the heating element 3 are cut, for example by milling. The flexible heating element 3 is laid in a meandering path and then connected to power supply bars 4. The heating device 1 can also be encased in a frame 5 and designed either as a hanging element or on legs. In addition, other elements, such as a temperature monitor, can be mounted in the base element.

FIG. 2 shows a cross-sectional view through a heating device 1, consisting of a base structure 2 and a heating element 3 embedded into it. On one flat face of the base structure 2, there is a cover plate 6, for which a plate made of glass-lined steel has proved particularly favourable. With this plate, the heat rays 7 from the heating element 3 can be emitted into the surrounding area virtually unhindered. The heating element 3 is placed in grooves 8 with a U-shaped cross-section. If the grooves 8 are manufactured with high precision, the heating element 3 is in direct contact with the base structure 2 along its entire length on both sides, thus it can transfer its heat energy to this structure, which in turn radiates the heat evenly. Furthermore, there is direct contact between heating element 3 and cover plate 6, thus also providing good heat transfer and subsequent heat distribution in the cover plate 6, which also leads to even heat emission.

This cover plate 6 makes irradiation more even, permitting favourable heating at an even room temperature. On the opposite flat face of the base structure 2, another cover plate 9 is provided that reflects the heat rays 10 and radiates them back through the base structure 2, made preferably of expanded glass, towards the remaining heat rays 7. Thus, there are few losses and it also becomes possible to hang the heating device 1 on a wall, for example, or use it for underfloor heating, without the risk of the wall or floor becoming too hot. The base structure 2 can also be enclosed in a frame 5, which can be made of wood, sheet metal or also aluminium.

By converting the electrical energy directly into heat energy in the heating element 3, the heat rays transfer the energy without any intermediary. The heat rays are generated immediately and perceptibly after the heating device 1 is switched on and heat all solid bodies in the room evenly. Thus, there is no need for air circulation, and this also does not occur. As a result, there is no dust raised either. Furthermore, an even temperature is achieved over the entire height of the room, unlike conventional heating devices where the warm air rises and the cooler air collects at floor level on the one hand, and where the wall is colder and this chill also radiates into the room on the other hand. With the heating device according to the invention, it is possible to make substantial energy savings of up to 50% compared with conventional heating systems.

1. Heating device consisting of a base plate and a heating element, wherein the base plate consists of an insulating material and the heating element is embedded in it, and the heating element is designed as a flexible, wire-shaped electrical heat conductor made of non-metallic material and is provided within a groove in the base plate.

2. Heating device according to claim 1, wherein the base plate is made of sintered expanded glass granulate.

3. Heating device according to claim 1, wherein the base plate consists of a honeycomb of aramid paper coated with phenolic resin or an aluminium honeycomb.

4. Heating device according to claims 1, wherein the heating element is made of a carbon wire.

5. (canceled)

6. Heating device according to claims 1, wherein a cover plate with irradiating properties is provided on a flat face of the base plate.

7. Heating device according to claim 6, wherein the cover plate is made of enamelled steel or lacquered aluminium sheet.

8. Heating device according to claim 6, wherein the heating element (3) is in direct contact with the cover plate (6).

9. Heating device according to claim 1, wherein a heat-reflecting cover plate is provided on the lower flat face of the base plate.

10. Heating device according to claim 10, wherein the heat-reflecting plate is made of sheet steel, aluminium sheet, or zinc sheet.

11. Heating device according to claim 7, wherein the heating element is in direct contact with the cover plate.
